(19) United States
(12) Patent Application Publication
(10) Pub. No.: US 2024/0424325 A1
(43) Pub. Date: Dec. 26, 2024

(54) Rescue Strap

(71) Applicant: Charles Henline, Boonsboro, MD (US)

(72) Inventor: Charles Henline, Boonsboro, MD (US)

(21) Appl. No.: 18/752,347

(22) Filed: Jun. 24, 2024

Related U.S. Application Data
(60) Provisional application No. 63/509,632, filed on Jun. 22, 2023.

(51) Int. Cl. A62B 35/00; A01M 31/00

(52) U.S. Cl. CPC A62B 35/0006; A01M 31/006

(57) ABSTRACT

A rescue strap composed of an elongated strap wherein the distal ends of said strap, each include a handle. The elongated strap may be composed of two separate straps wherein each strap is adjustably coupled via a cam buckle that provides a user to adjust the length of the elongated strap. To aid in the process of adjusting the length, the rescue strap further includes a pull ring for users to easily grab the end of the strap. Additionally, the rescue strap includes a plurality of carabiners to attach the rescue strap to the SCBA shoulder straps of a downed firefighter, thus enabling the user to easily transport the downed firefighter, without risk of the downed firefighter disengaging with the rescue strap.

### FIELD OF THE INVENTION

The present invention relates generally to a fire rescue strap. More specifically, the present invention is a fire rescue strap for hoisting, lifting, and dragging downed firefighters and civilians in emergency situations.

### BACKGROUND OF THE INVENTION

Firefighters play a crucial role in rescuing and protecting lives during emergencies. In the line of duty, they often face challenging situations where they may need assistance in dragging, lifting, or hoisting downed firefighters. Various devices and methods have been developed to aid in these rescue operations. However, many of the existing solutions suffer from certain disadvantages, hindering their effectiveness and efficiency.

One common approach is the use of harnesses or straps connected to the downed firefighter. These devices typically involve intricate configurations and complex attachment mechanisms, which can be time-consuming and cumbersome to operate under the stress of an emergency. Furthermore, the existing solutions often lack versatility, making them less suitable for different rescue scenarios.

Another drawback of the prior art is the absence of a user-friendly adjustability feature. Firefighters work in diverse environments and encounter various physical conditions during rescues. The inability to quickly adjust the length of the rescue strap can impede their ability to maneuver and perform efficient rescue operations.

An objective of the present invention is to provide a fire rescue strap that overcomes the limitations of the prior art. The strap aims to simplify the process of dragging, lifting, or hoisting downed firefighters, enhancing their chances of rescue while ensuring the safety of both the rescuers and the victims.

Another objective of the present invention is to offer a versatile and adaptable solution suitable for different rescue scenarios. By incorporating adjustable features, the strap can be customized to accommodate various body sizes and rescue conditions, enabling quick and effective deployment during emergencies.

Additionally, the present invention seeks to improve the ease of use, ensuring that firefighters can swiftly connect and disconnect the strap without wasting valuable time. By incorporating user-friendly handles, carabiners, and a cam buckle, the invention facilitates intuitive operation even under high-stress situations, minimizing the risk of errors during rescue operations.

The strap's design simplifies the process of connecting and disconnecting it to the SCBA shoulder straps, allowing for quick deployment even under stressful conditions. The handles provide a secure grip for the rescuer, enabling them to exert force and maintain control while maneuvering the downed firefighter. Furthermore, the handles of the invention provide an accessible connection point for a hoisting system during operation. The strategically positioned carabiners ensure reliable attachment to the shoulder straps, minimizing the risk of slippage and enhancing the safety of the rescue operation.

The inclusion of a cam buckle allows for easy adjustment of the strap's length, catering to different body sizes and rescue conditions. Firefighters can swiftly loosen or tighten the cam buckle to customize the fit and ensure a secure and comfortable connection to the downed firefighter. This adjustability feature enhances versatility and adaptability, making the strap suitable for a wide range of rescue scenarios. Furthermore, the O-Ring pull-ring adds an extra dimension of versatility to the fire rescue strap. By utilizing the pull-ring, firefighters can connect additional equipment or accessories, expanding the functionality of the strap beyond dragging, lifting, or hoisting. Additionally, the O-ring provides an easily identifiable marker for adjusting the strap during low visibility conditions. This functionality enables the rescuer to adapt the strap to meet specific rescue needs, further enhancing the efficiency and effectiveness of the rescue operation.

### SUMMARY OF THE INVENTION

The present invention is a fire rescue strap designed to aid in dragging, lifting, or hoisting downed firefighters. It consists of an elongated strap, equipped with two handles positioned on each end. Located proximate each handle are carabiners, providing attachment points for securing the strap to the SCBA (Self-Contained Breathing Apparatus) shoulder straps of the downed firefighter. The strap also features a cam buckle, allowing for easy adjustment of its length, and an O-Ring pull-ring for additional versatility.

The arrangement of the components within the present invention ensures its practicality and efficiency during rescue operations. The handles, positioned at both ends of the strap, offer a grip for the rescuer, enabling them to drag, lift, or hoist the downed firefighter. The carabiners, located proximate the handles, provide secure attachment points to the SCBA shoulder straps, ensuring reliable connection and minimizing the risk of slippage during rescue.

The incorporation of a cam buckle allows for adjustment of the strap's length. This feature is vital in adapting to various rescue scenarios, accommodating different body sizes, and optimizing the efficiency of the rescue operation. By simply loosening or tightening the cam buckle, the rescuer can customize the strap's length as needed, ensuring a snug and secure fit around the downed firefighter.

The fire rescue strap described in this invention aims to address the disadvantages of prior art solutions and provide an innovative and improved approach to dragging, lifting, or hoisting downed firefighters. By incorporating user-friendly handles, carabiners, a cam buckle, and an O-Ring pull-ring, the present invention offers a versatile and adaptable solution that enhances the efficiency and effectiveness of rescue operations.

The present invention provides a comprehensive solution to the challenges faced during fire rescue operations. The fire rescue strap, with its intuitive design and innovative features, offers a user-friendly and adaptable tool for dragging, lifting, or hoisting downed firefighters. By addressing the disadvantages of prior art solutions and incorporating versatile components, the invention significantly improves the efficiency, safety, and effectiveness of rescue operations, ultimately saving lives and safeguarding the well-being of both firefighters and victims.

### BRIEF DESCRIPTION OF THE DRAWINGS

FIG. 1 is a perspective view of the present invention.

FIG. 2 is a top view of the present invention having a cut section.

FIG. 3 is a detailed view of the present invention showing the cam buckle.

FIG. 4 is a top view of the present invention having a cut section.

FIG. 5 is a detailed view of the handles of the present invention.

FIG. 6 is a diagram of the present invention in its intended use.

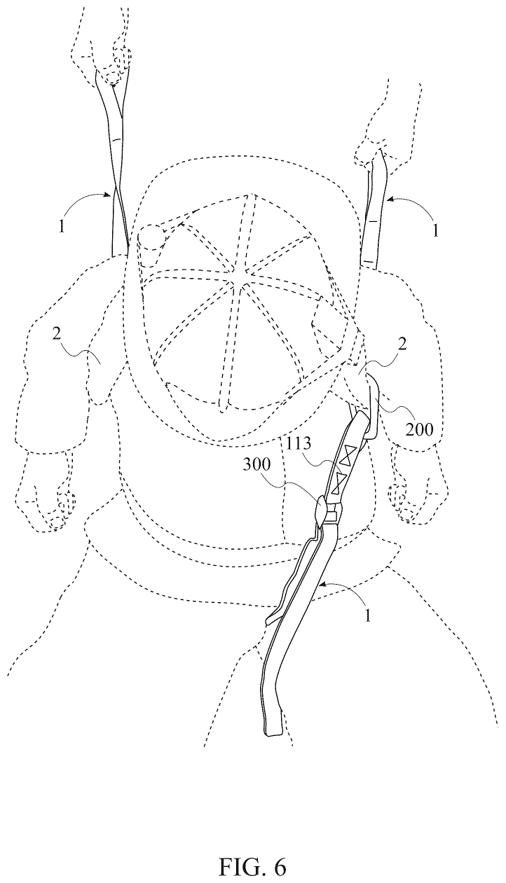

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification, and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate.

The present disclosure includes many aspects and features. Moreover, while many aspects and features relate to, and are described in the context of a rescue strap 1, embodiments of the present disclosure are not limited to use only in this context.

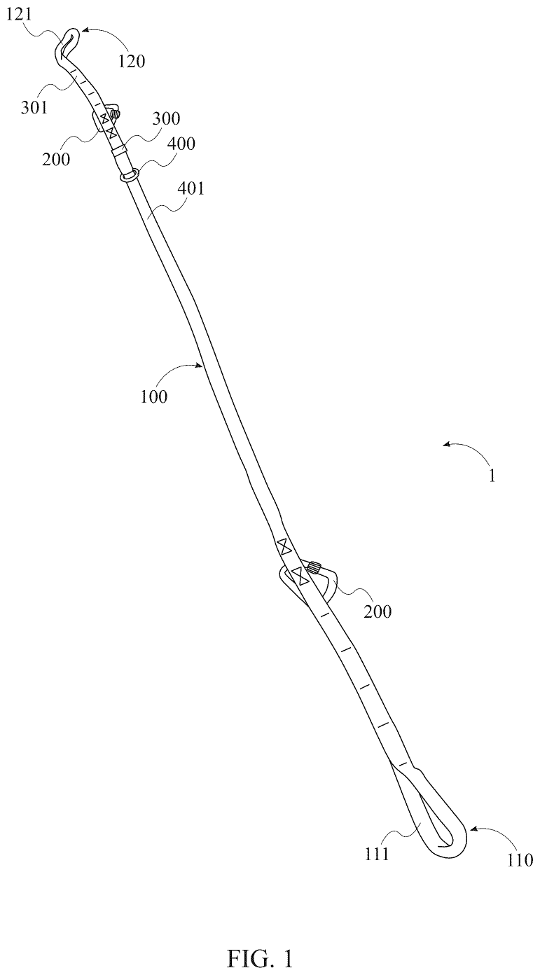

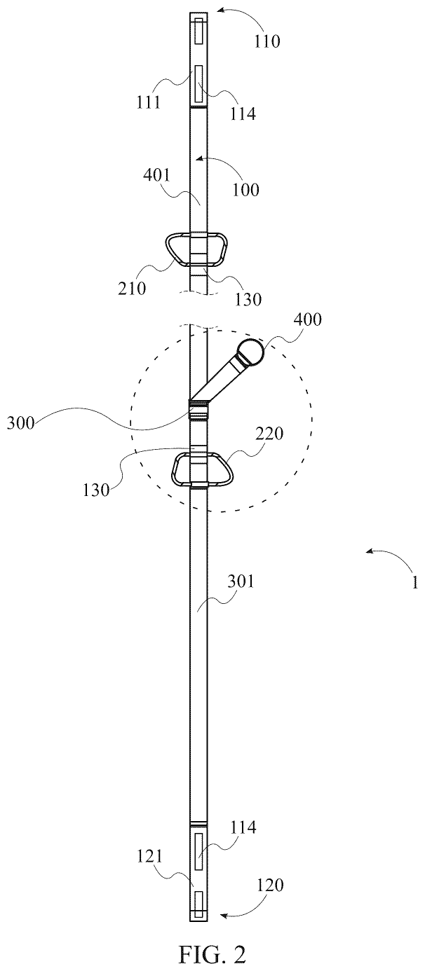

As shown in FIG. 1, the present invention is a rescue strap 1 composed of an elongated strap 100 comprising a plurality of ends, an at least one carabiner 200, a cam buckle 300, and a pull ring 400. In the preferred embodiment of the present invention the plurality of ends, preferably composing a quantity of two ends; a first end 110 and a second end 120, are opposing distal ends of the elongated strap 100 composing the rescue strap 1, wherein each of the plurality of ends comprises a handle: a first handle 111 and a second handle 121, respectively. Furthermore, as shown in FIG. 2, in the preferred embodiment of the present invention, the elongated strap 100 is composed of a first strap member 301 and a second strap member wherein: the first strap member 301 comprises a first distal end 110 and a second distal end (a proximal end within the context of the present invention), wherein the first distal end 110 of the first strap member 301 comprises the first handle 111 and the second distal end of the first strap member 301 is fixedly coupled to the cam buckle 300; and the second strap member 401 comprises a first distal end 121 and a second distal end (a proximal end within the context of the present invention), wherein the first distal end 120 of the second strap member 401 comprises the second handle 121 and the second distal end of the second strap member 401 is coupled to the pull ring 400, whereby the second strap member 401 adjustably engages with the cam buckle 300 at a variable location between the pull ring 400 and the second handle 121. Additionally, within the context of the present invention, the first strap member 301 and the second strap member 401 each comprise a distal end (110 and 120, respectively) and a proximal end wherein the proximal ends of each strap member are adjacently coupled, whereby the distal ends form the opposing distal ends of the elongated member as discussed herein. Moreover, the at least one carabiner 200, in the preferred embodiment of the present invention, comprise two carabiners, wherein each strap member composing the elongated strap 100 comprises a carabiner located between the distal end and the proximal end of each strap member.

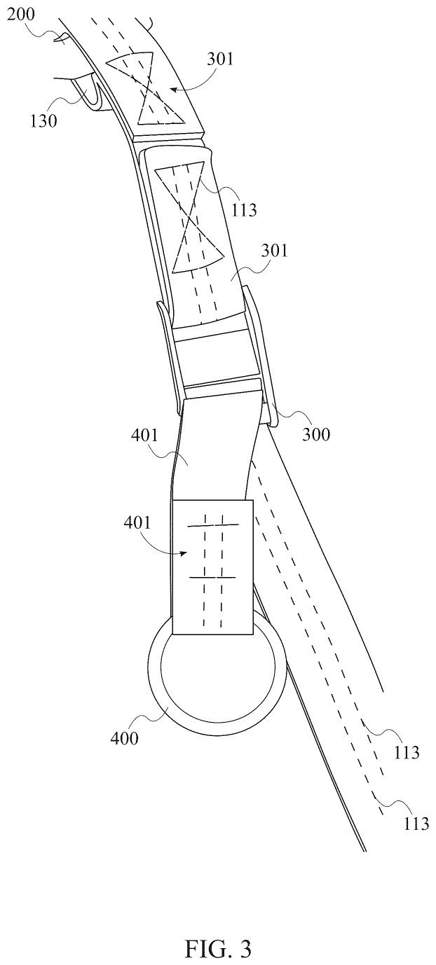

As shown in FIG. 2 and FIG. 3, in the preferred embodiment of the present invention, the elongated strap 100 further comprises a plurality of securement openings 130 laterally traversing the elongated strap 100, containing the carabiners in a fixed location on the elongated strap 100. In the preferred embodiment, each of the first strap member 301 and the second strap member 401 comprise an at least one securement opening 130. Furthermore, as shown in FIG. 3, in the preferred embodiment of the present invention, the second strap member 401 of the elongated strap 100 engages with the cam buckle 300, in a manner that allows a user to pull the pull ring 400 to adjust the length of the elongated strap 100, measured between the first handle 111 and the second handle 121. Additionally, in the preferred embodiment, the present invention comprises a plurality of reinforced stitches 113 wherein said reinforced stitches 113 are provided to decrease the probability of failure at locations of the present invention that may experience high stress and force when being used in its preferred utility. In some embodiments of the present invention, the reinforced stitches 113 may traverse the length of the present invention. In further embodiments of the present invention, the reinforced stitches 113 may be used to secure components such as the handles, the carabiners, and the pull ring 400, as in the preferred embodiment of the present invention, the user will exert a force onto said components.

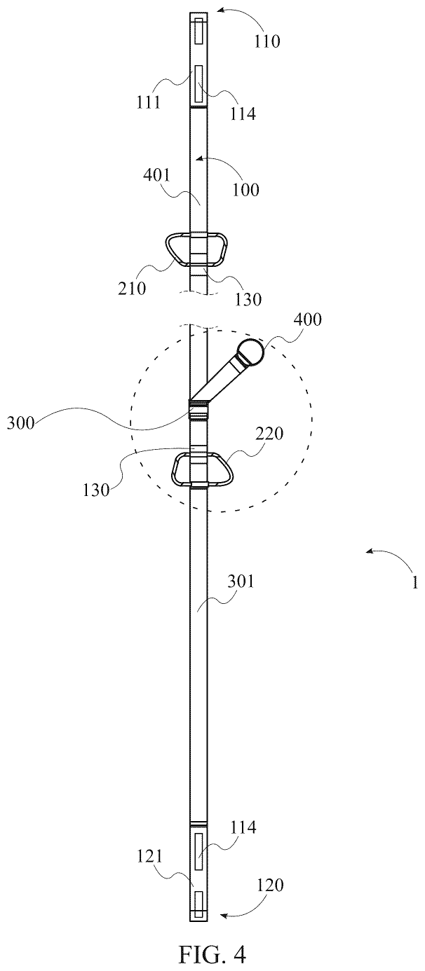

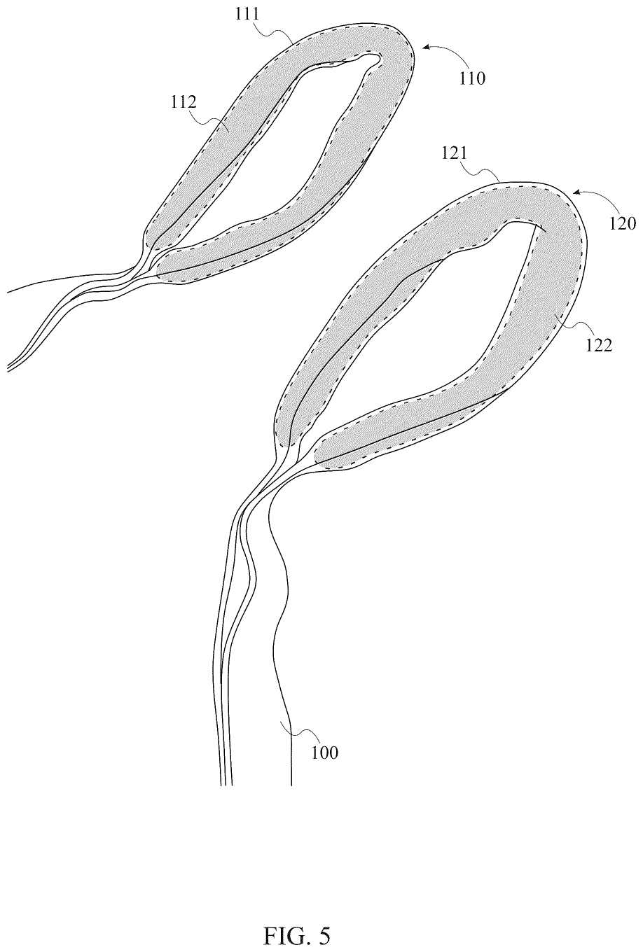

As shown in FIG. 4, in some embodiments of the present invention, each handle further comprises a reflective member 114. In such embodiments, the reflective member 114 may provide the user with a point of reference when using the invention is low-visibility conditions such as in situations involving low light (darkness) and airborne particulate matter (smoke and fog). Furthermore, in some embodiments, as shown in FIG. 5, the present invention may comprise padded handles, wherein a padding material 112 is provided within the handle. In some embodiments of the present invention, the padding material 112 may be composed of a length of rope, interposed between a flexible member, although the present invention is not limited to such. In the context of the present invention, a “padded handle” may be synonymous with an ergonomic handle, wherein said handle reduces the pressure exerted onto the hand of the user, in relation to the elongated strap interposed between the handles. Furthermore, in the preferred embodiment of the present invention, the plurality of handles are composed of a looped portion of the elongated strap 100.

To use the present invention, as shown in FIG. 5, the rescue strap 1 is routed between the legs of a downed individual. The first carabiner and the second carabiner are then hooked to the SCBA shoulder straps 2 of the downed individual. The pull ring 400 is pulled, thus reducing the slack (length) of the elongated strap 100. The first handle 111 and the second handle 121 are then used to drag, hoist, and/or lift the downed firefighter.

Although the invention has been explained in relation to its preferred embodiment, it is to be understood that many other possible modifications and variations can be made without departing from the spirit and scope of the invention.

What is claimed is:

1. A rescue strap comprising:
an elongated strap; and
a plurality of carabiners;
wherein:
the elongated strap comprises a first end and a second end wherein said ends are opposing distal ends of the elongated strap;
the first end of the elongated strap comprising a first handle wherein said first handle is composed of a looped portion of the elongated strap;
the second end of the elongated strap comprising a second handle wherein said second handle is composed of a looped portion of the elongated strap; and
the plurality of carabiners interposed between the first end and the second end.

2. The rescue strap as claimed in claim 1 wherein the elongated strap is composed of a first strap member and a second strap member.

3. The rescue strap as claimed in claim 2 further comprising a cam buckle;
the cam buckle interposed between the first strap member and the second strap member;
the first strap member being fixedly coupled to the cam buckle;
the first strap member comprising the first end comprising the first handle, and a second opposing end wherein said second end is fixedly coupled to the cam buckle;
the second strap member comprising the second end comprising the second handle, and an opposing end wherein said opposing end of the second strap member is adjustably engaged to the cam buckle, providing a means for the cam buckle to be positioned at a location between the second handle and the opposing end of the second strap member.

4. The rescue strap as claimed in claim 3 wherein the opposing end of the second strap member comprises a pull ring.

5. The rescue strap as claimed in claim 1 wherein each handle comprises a padding material contained within the handle.

6. The rescue strap as claimed in claim 4 further comprising reinforced stitching.

7. The rescue strap as claimed in claim 1 further comprising a reflective member located on the elongated strap.

8. The rescue strap as claimed in claim 2 wherein each of the strap members of the elongated strap comprise an at least one securement opening;
each securement opening allowing one carabiner to traverse through, thus coupling each carabiner to a fixed location along the elongated strap.

9. A rescue strap comprising:
an elongated strap composed of a first strap member and a second strap member; and
a plurality of carabiners;
wherein:
the first strap member and the second strap member each comprise a distal end and a proximal end;
the proximal ends of the first strap member and the second strap member being adjacently coupled;
the distal ends of the first strap member and the second strap member forming opposing ends of the elongated strap member, thus the elongated strap comprises a first end and a second end wherein said ends are opposing distal ends of the elongated strap whereby;
the first end of the elongated strap, being the distal end of the first strap member, comprising a first handle wherein said first handle is composed of a looped portion of the elongated strap;
the second end of the elongated strap, being the distal end of the second strap member, comprising a second handle wherein said second handle is composed of a looped portion of the elongated strap; and
the plurality of carabiners interposed between the first end and the second end.

10. The rescue strap as claimed in claim 9 wherein each of the strap members of the elongated strap comprise an at least one securement opening;
each securement opening allowing one carabiner to traverse through, thus coupling each carabiner to a fixed location along the elongated strap.

11. The rescue strap as claimed in claim 10 further comprising a pull ring wherein said pull ring is secured to the proximal end of the second strap member.

12. The rescue strap as claimed in claim 11 further comprising a cam buckle wherein the proximal end of the first strap member is fixedly secured to the cam buckle; and
the second strap member is adjustably engaged with the cam buckle whereby the cam buckle may be positioned at a position along the second strap member between the second handle and the pull ring.

13. The rescue strap as claimed in claim 12 wherein each handle comprises a padding material contained within the handle.

14. The rescue strap as claimed in claim 12 further comprising reinforced stitching.

15. The rescue strap as claimed in claim 12 further comprising a reflective member located on the elongated strap.

16. A rescue strap comprising:
an elongated strap composed of a first strap member and a second strap member;
a cam buckle; and
a plurality of carabiners;
wherein:
the first strap member and the second strap member each comprise a distal end and a proximal end;
the proximal end of the first strap member being fixedly coupled to the cam buckle;
the second strap member being adjustably coupled to the cam buckle;
the distal ends of the first strap member and the second strap member forming opposing ends of the elongated strap member, thus the elongated strap comprises a first end and a second end wherein said ends are opposing distal ends of the elongated strap whereby; and
each strap member comprising at least one of the plurality of carabiners.

17. The rescue strap as claimed in claim 16 wherein:
the first end of the elongated strap, being the distal end of the first strap member, comprising a first handle wherein said first handle is composed of a looped portion of the elongated strap; and
the second end of the elongated strap, being the distal end of the second strap member, comprising a second handle wherein said second handle is composed of a looped portion of the elongated strap.

18. The rescue strap as claimed in claim 17 wherein each handle comprises a padding material contained within the handle.

19. The rescue strap as claimed in claim 18 further comprising reinforced stitching.

20. The rescue strap as claimed in claim 19 further comprising a reflective member located on the elongated strap.
